(19) United States
(12) Patent Application Publication
(10) Pub. No.: US 2024/0169561 A1
(43) Pub. Date: May 23, 2024

(54) IMAGE TRACKING METHOD AND IMAGE TRACKING SYSTEM

(71) Applicant: KINPO ELECTRONICS, INC., NEW TAIPEI CITY (TW)

(72) Inventor: Kuo-Sen TSENG, NEW TAIPEI CITY (TW)

(21) Appl. No.: 18/104,301

(22) Filed: Feb. 1, 2023

(30) Foreign Application Priority Data
Nov. 22, 2022 (CN) 202211474201.6

(51) Int. Cl. G06T 7/246; G06T 7/00; G06T 7/12; G06T 7/73; G06V 10/22

(52) U.S. Cl. CPC G06T 7/248; G06T 7/0002; G06T 7/12; G06T 7/74; G06V 10/225; G06T 2207/10024

(57) ABSTRACT

Image tracking method and image tracking system are provided. The image tracking method includes capturing an initial image including a plurality of object-to-be-detected images. Each object-to-be-detected image includes a tracking region and a main region, and a pixel difference between the tracking region and the main region is greater than a threshold. The method includes executing an image processing on the initial image to obtain a binary image including a plurality of image object contours, computing a minimum bounding rectangle of each image object contour, and comparing the minimum bounding rectangle of each image object contour with a default rectangle to choose the minimum bounding rectangle matching the default rectangle to be a positioning region. The method includes generating an identifying box according to the positioning region and displaying the initial image tagged with the identifying box which overlays on the tracking region.

### BACKGROUND OF THE DISCLOSURE

### Technical Field

The technical field relates to an image tracking method and an image tracking system, and more particularly, to an image tracking method and an image tracking system for tracking and tagging an object among multiple objects.

### Description of Related Art

The image tracking technique is implemented for identifying objects in the environment in the image and tracking the objects in the image. The related art provides object tracking technique based on a specific feature of the object, but it is incapable of determining which object to track when there are many similar objects in the environment. When many similar objects are adjacent to each other or overlapped partially, the objects in the image may be wrongly identified. In addition, because the objects are adjacent to each other or overlapped partially, it is impossible to determine which object is the tracked object and the tracked object cannot be specifically indicated in the image. The situation induces errors in the successive image tracking, so the user cannot recognize which object is currently being tracked in the image.

Accordingly, how to indicate correctly the tracked object among many similar objects is a technical problem that the invention desires to solve.

### SUMMARY OF THE DISCLOSURE

One of the exemplary embodiments of the disclosure is to provide an image tracking method including: capturing an initial image by an image capturing device, wherein the initial image includes a plurality of object-to-be-detected images, each object-to-be-detected image includes a tracking region and a main region, wherein a pixel difference between the tracking region and the main region is greater than a threshold; executing an image processing on the initial image to obtain a binary image, wherein the binary image includes a plurality of image object contours; computing respectively a minimum bounding rectangle of each of the plurality of image object contours; comparing the minimum bounding rectangle of each of the plurality of the image object contours with a default rectangle to choose the minimum bounding rectangle matching the default rectangle to be a positioning region; generating an identifying box according to the positioning region; and displaying, on a display device, the initial image tagged with the identifying box, wherein the identifying box overlays on the tracking region of one of the plurality of plurality of object-to-be-detected images.

One of the exemplary embodiments of the disclosure is to provide an image tracking system including: an image capturing device, a display device, and a processing device. The image capturing device is configured to capture images on a plurality of to-be-detected objects to obtain an initial image, the initial image comprises a plurality of object-to-be-detected images, each of the plurality of object-to-be-detected images includes a tracking region and a main region, and a pixel difference between the tracking region and the main region is greater than a threshold. The display device is configured to display the initial image. The processing device is connected with the image capturing device and the display device and is configured to execute an image processing on the initial image to obtain a binary image, wherein the binary image includes a plurality of image object contours. The processing device is configured to compute respectively a minimum bounding rectangle of each of the plurality of image object contours, compare the minimum bounding rectangle of each of the plurality of the image object contours with a default rectangle to choose the minimum bounding rectangle matching the default rectangle to be a positioning region, generate an identifying box according to the positioning region, and display, on a display device, the initial image tagged with the identifying box, wherein the identifying box overlays on the tracking region of one of the plurality of plurality of object-to-be-detected images.

### BRIEF DESCRIPTION OF THE DRAWINGS

FIG. 1 is a block diagram illustrating an image tracking system in accordance with one embodiment of the present disclosure.

FIG. 2 is a schematic diagram of an object-to-be-detected image in accordance with one embodiment of the present disclosure.

FIG. 3 is a schematic diagram of an initial image captured from a plurality of to-be-detected objects placed on an inspection platform in accordance with one embodiment of the present disclosure.

FIG. 4 is a flowchart illustrating an image tracking method in accordance with one embodiment of the present disclosure.

FIG. 5 is a schematic diagram illustrating a binary image in accordance with one embodiment of the present disclosure.

FIG. 6 is a schematic diagram illustrating a minimum bounding rectangle computed from the binary image illustrated in FIG. 5 in accordance with one embodiment of the present disclosure.

FIG. 7 is a schematic diagram illustrating an identifying box displayed on the initial image in accordance with one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

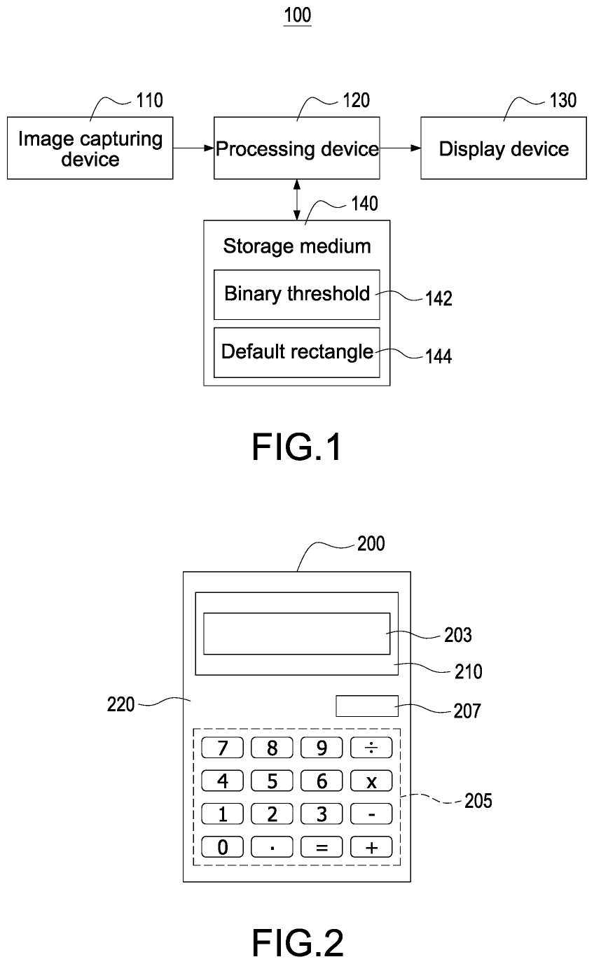

Reference is made to FIG. 1. FIG. 1 is a block diagram illustrating an image tracking system in accordance with one embodiment of the present disclosure. The image tracking system 100 includes an image capturing device 110, a processing device 120, a display device 130, and a storage medium 140. The processing device 120 is connected with the image capturing device 110, the display device 130, and the storage medium 140. The image capturing device 110 is configured to capture continuously initial images of a plurality of to-be-detected objects placed on a platform (not shown in Figures) and provide the initial images to the processing device 120 for the processing device 120 to perform image identifications to indicate the to-be-detected object which is tracked. The display device 130 is configured to display the initial image. The storage medium 140 is configured to store programs including information of a binary threshold 142 for executing an image processing and a default rectangle 144.

In one embodiment, the plurality of to-be-detected objects placed on the platform are same reproduction objects, such as calculators, tablets, or other products to be detected. In other embodiments, the plurality of to-be-detected objects placed on the platform are different kinds of objects. In the specification, the terms “to-be-detected physical object” and “to-be-detected object” are used interchangeably, and the term “object-to-be-detected image” indicates the image of the to-be-detected physical object or the image of the to-be-detected object.

The initial image captured by the image capturing device 110 includes a plurality of object-to-be-detected images, and each of the plurality of object-to-be-detected images includes a tracking region and a main region. In one embodiment, the tracking region is a hollow rectangle having a width. The main region is the region other than the tracking region. A pixel difference exists between the tracking region and the main region and the pixel difference is greater than a threshold.

In one embodiment, the hollow rectangle includes an external rectangle and an internal rectangle, and the internal rectangle is inside the external rectangle. The coverage between the external rectangle and the internal rectangle forms the area of the hollow rectangle. The external rectangle and the internal rectangle include respectively two pairs of parallel edges. A first pair of the parallel edges of the external rectangle is perpendicular to the second pair of the parallel edges of the external rectangle. A first pair of the parallel edges of the internal rectangle is perpendicular to the second pair of the parallel edges of the internal rectangle. The first pair of the parallel edges of the external rectangle is parallel to the first pair of the parallel edges of the internal rectangle. The second pair of the parallel edges of the external rectangle is parallel to the second pair of the parallel edges of the internal rectangle. The width of the hollow rectangle includes a vertical distance (such as 50 pixels) between an edge (a first edge) of the first pair of the parallel edges of the external rectangle and an edge (a first edge) of the first pair of the parallel edges of the internal rectangle which is closest to the first edge of the first pair of the parallel edges of the external rectangle, a vertical distance (such as 50 pixels) between another edge (a second edge) of the first pair of the parallel edges of the external rectangle and another edge (a second edge) of the first pair of the parallel edges of the internal rectangle which is closest to the second edge of the first pair of the parallel edges of the external rectangle, a vertical distance (such as 20 pixels) between an edge (a first edge) of the second pair of the parallel edges of the external rectangle and an edge (a first edge) of the second pair of the parallel edges of the internal rectangle which is closest to the first edge of the second pair of the parallel edges of the external rectangle, a vertical distance (such as 20 pixels) between another edge (a second edge) of the second pair of the parallel edges of the external rectangle and another edge (a second edge) of the second pair of the parallel edges of the internal rectangle which is closest to the second edge of the second pair of the parallel edges of the external rectangle, and the distance of a vertex pair (such as 54 pixels) between a vertex of the external rectangle and a vertex of the internal rectangle that the vertex of the internal rectangle is closest to the vertex of the external rectangle (e.g., the vertex pair formed by the upper left vertex of the external rectangle and the upper left vertex of the internal rectangle), and there are four vertex pairs. In one embodiment, the tracking region is formed with black pixels (e.g., the pixel value is between 0 and 49) and the main region is formed with white pixels (e.g., the pixel value is between 200 and 255). In the embodiment, a pixel difference between the tracking region and the main region is greater than a threshold (such as 150 pixel).

In one embodiment, the image capturing device 110 includes a camera.

In one embodiment, the processing device 120 may be but not limited to the central processing unit (CPU), the system on chip (SoC), the processor for specific applications, the audio processor, the digital signal processor, the processing chip, or the controller for specific functions.

In one embodiment, the display device 130 includes a display, a projector, or any electronic device with display function.

In one embodiment, storage medium 140 may be but not limited to the random access memory (RAM), the nonvolatile memory (such as the flash memory), the read-only memory (ROM), the hard disk drive (HDD), the solid-state drive (SSD), or the optical storage.

For facilitating the understanding, the disclosure takes the calculator as one example of the to-be-detected object, but the to-be-detected object is not limited to the calculator.

Reference is made to FIG. 2. FIG. 2 is a schematic diagram of an object-to-be-detected image in accordance with one embodiment of the present disclosure. In the embodiment, the object-to-be-detected image 200 is the image of the calculator. As shown in FIG. 2, the object-to-be-detected image 200 includes a tracking region 210 and a main region 220.

The tracking region 210 may be a geometric pattern having unique or special feature of the object-to-be-detected image 200, such that the geometric pattern having unique or special feature may be considered as a candidate trackable image in the disclosure. Furthermore (as described below), after the tracking region 210 is processed by the image processing, the image tracking system 100 may obtain the specific pixels corresponding to the default interested feature. For example, a display screen 203 of the calculator may be considered as the tracking region 210. In the other example, a solar panel 207 of the calculator may be also considered as the tracking region 210; however, buttons 205 are small blocks of the similar size, so the buttons 205 are not taken as the first priority as the candidate trackable image for the tracking region 210.

In one embodiment, the exterior part of the display screen 203 of the calculator has a colored frame and the colored frame is black or near black. Because the tracking region 210 is the exterior part of the display screen 203 of the calculator, the tracking region 210 is the hollow rectangle (the hollow part is the display screen 203) having the width and the color of the tracking region 210 is black or near black. The main region 220 is the regions other than the tracking region 210 of the object-to-be-detected image 200, for example, the white housing of the calculator and the multiple small blocks other than the tracking region 210 which have white color or near white color such as the button 205 and the solar panel 207.

In one embodiment, the external rectangle of the hollow rectangle corresponds to the tracking region 210 of the calculator, and the internal rectangle of the hollow rectangle corresponds to the display screen 203 of the calculator.

In one embodiment, the tracking region 210 has the pixel value of the black color (e.g., the pixel value is between 0 to 49), and the main region 220 has the pixel value of the white color (e.g., the pixel value is between 200 to 255). In the embodiment, the pixel difference between the tracking region 210 and the main region 220 is greater than the threshold (such as 150 pixel).

In one embodiment, the pixel difference between the tracking region 210 and the main region 220 is a difference value of the gray scale.

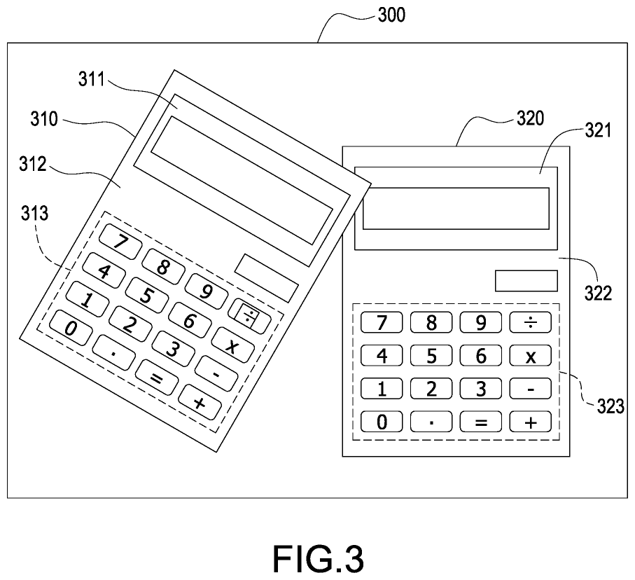

Reference is made to FIG. 3. FIG. 3 is a schematic diagram of an initial image captured from a plurality of to-be-detected objects placed on an inspection platform in accordance with one embodiment of the present disclosure. The initial image 300 includes calculator images 310 and 320 (i.e., the plurality of object-to-be-detected images). The two calculators of the calculator images 310 and 320 are the products having same model, appearance, and operating function.

In one embodiment, the plurality of object-to-be-detected images correspond to the plurality of to-be-detected objects. As shown in FIG. 3, the two object-to-be-detected images, such as the calculator images 310 and 320, are captured from the two to-be-detected objects.

In some circumstances, the to-be-detected objects are collided with each other or moved on the platform while the conveyor transports the to-be-detected objects, such that some of the to-be-detected objects are adjacent to each other or partially overlapped. As shown in FIG. 3, the upper right part of the left calculator slightly leans on the left side of the right calculator, such that the calculator image 310 and the calculator image 320 are partially overlapped. For the sake of brevity, the appearance, operating function, and feature description of the calculator images 310 and 320 are the same with those of the calculator image 200 in FIG. 2. The statement “the to-be-detected objects are adjacent to each other” means that the to-be-detected objects are not entirely overlapped with each other though, they are very close to each other or even partially and physically touched with each other. Because the inspection program of the related art only detects the outline of the entire to-be-detected object, it can neither to respectively identify/indicate the entities of the two to-be-detected objects of the image, nor to indicate correctly which to-be-detected object is the tracked object among the to-be-detected objects adjacent to each other to result in error tracking.

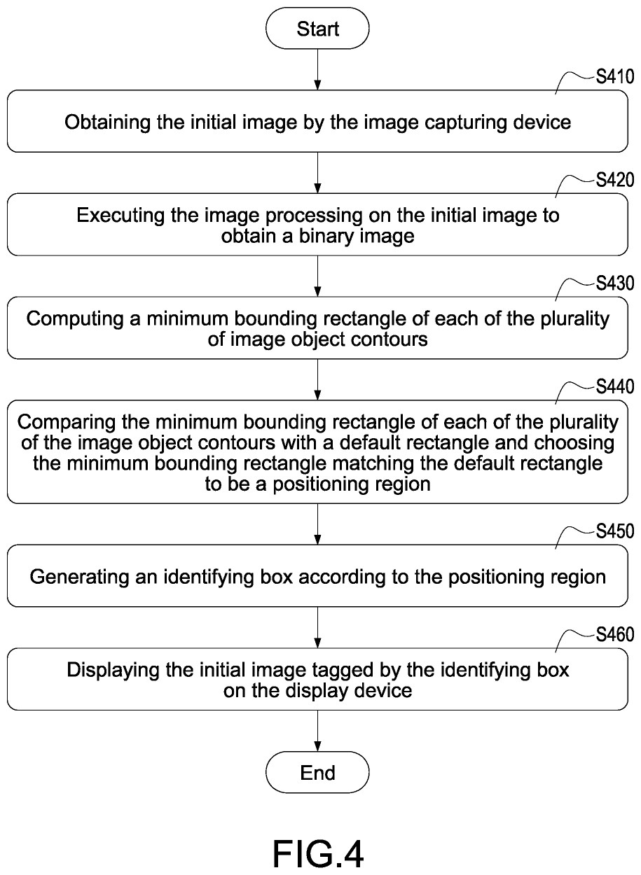

Reference is made to FIG. 4. FIG. 4 is a flowchart illustrating an image tracking method in accordance with one embodiment of the present disclosure. The image tracking method of FIG. 4 may be performed by the image tracking system 100 of FIG. 1, and each step of the image tracking method is illustrated incorporating with FIGS. 3, 5, and 6 as below.

In step S410, the initial image is captured by the image capturing device 110. In one embodiment, the image capturing device 110 captures continuously the initial image and provides the initial image to the display device 130 so that the user may see the initial image on the display device 130.

In step S420, the image processing is executed on the initial image to obtain a binary image. The binary image includes a plurality of image object contours. In one embodiment, the image processing may be but not limited to the binary thresholding computation (THRESH_BINARY) of OpenCV (Open Source Computer Vision Library), the inverse-binary thresholding computation (THRESH_BINARY_INV), the truncate thresholding computation (THRESH_TRUNC), the threshold to zero computation (THRESH_TOZERO), or the inverted threshold to zero computation (THRESH_TOZERO_INV). The initial image is processed by the image processing executed by the processing device 120 and the binary image (or called “monochromatic image”) is generated accordingly.

In one embodiment, the binary threshold 142 is a threshold value used for classifying the gray scale of the image, and the pixel value of the image is classified into 0 or 1 based on the threshold value. Before executing the image processing, the processing device 120 determines according to the plurality of object-to-be-detected images and records the binary threshold. The determined binary threshold 142 has a good processing effect. The recorded binary threshold 142 is used for processing the same duplications afterward to perform the binary image process. It should be noticed that the good processing effect means that the binary threshold 142 increases the effect of extracting the tracking region from the initial image.

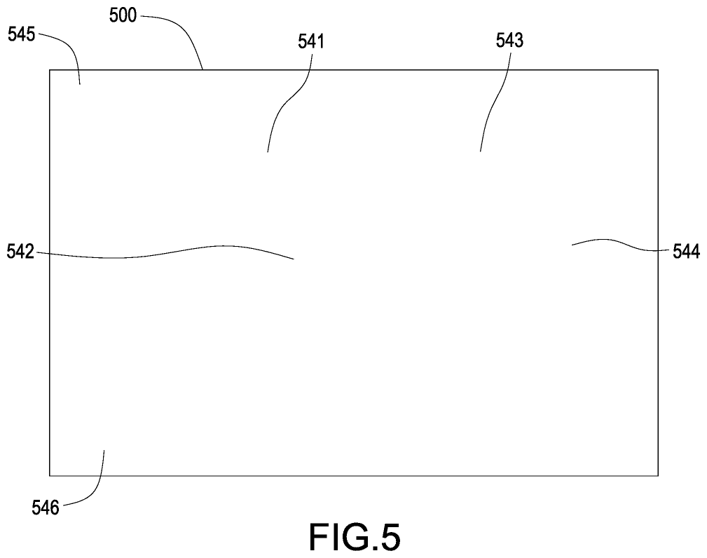

Reference is made to FIG. 5. FIG. 5 is a schematic diagram illustrating a binary image in accordance with one embodiment of the present disclosure. The binary image 500 of FIG. 5 is the monochromatic image. The infilled region of the binary image 500 represents the black pixel of the binary image 500, and the regions other than the filled region represent the white pixel of the binary image 500. In one embodiment, the image processing executed by the processing device 120 may convert the white pixel of the main regions 312 and 322 shown in FIG. 3 and the white pixel or the light color pixel of the plurality of small blocks 313 and 323 into the black pixel shown in FIG. 5, and convert the black pixel of the tracking regions 311 and 321 shown in FIG. 3 into the white pixel shown in FIG. 5. The default interested feature of the image tracking system 100 corresponds to the specific pixel, that is, the white pixel.

The white pixel of the binary image 500 shown in FIG. 5 forms the plurality of regions 541 to 546, and the regions 541 to 546 are white and irregular. The processing device 120 executes the boundary detection algorithm to the binary image 500 and computes the image object contours of the regions 541 to 546 respectively. In one embodiment, the image object means the pixel block having same pixel values, and the pixels of the edge of the pixel block form the contour of the image object. For example, the region 541 shown in FIG. 5 is the white block, and the region 541 is formed by the plurality of the white pixels. The center part of the region 541 has the small infilled rectangle, and the shape of the white block (i.e., the region 541) is similar to the white hollow rectangle. In one embodiment, any image object contour may be the contour formed by the junction between the white pixel and the black pixel of the binary image 500.

In one embodiment, the processing device 120 applies the binary threshold in the image processing to convert the pixels of the initial image, so the pixel of the tracking regions 311 and 321 (shown in FIG. 3) is converted into a first color pixel, and the first color pixel is one of black pixel and white pixel of the binary image 500 (shown in FIG. 5); the pixel of the main regions 312 and 322 (shown in FIG. 3) and the pixel of the plurality of small blocks 313 and 323 (shown in FIG. 3) are converted into a second color pixel, and the second color is the other of the black pixel and the white pixel of the binary image 500 (shown in FIG. 5).

In one embodiment, the first color pixel is the white pixel and the second color pixel is the black pixel.

In one embodiment, the default interested feature of the image tracking system 100 corresponds to the specific pixel, that is, the white pixel.

Due to converting the initial image into the binary image, some image blocks of the initial image (such as the button of the calculator) may be erased in the stage. Therefore, the image data computation of the processing device 120 is reduced and the speed of tracking the to-be-detected object is increased in the follow-up image object tracking.

Referring back to FIG. 4, in step S430, a minimum bounding rectangle of each of the plurality of image object contours is computed by the processing device 120. In one embodiment, the minimum bounding rectangle is the smallest rectangle that encircles one image object contour.

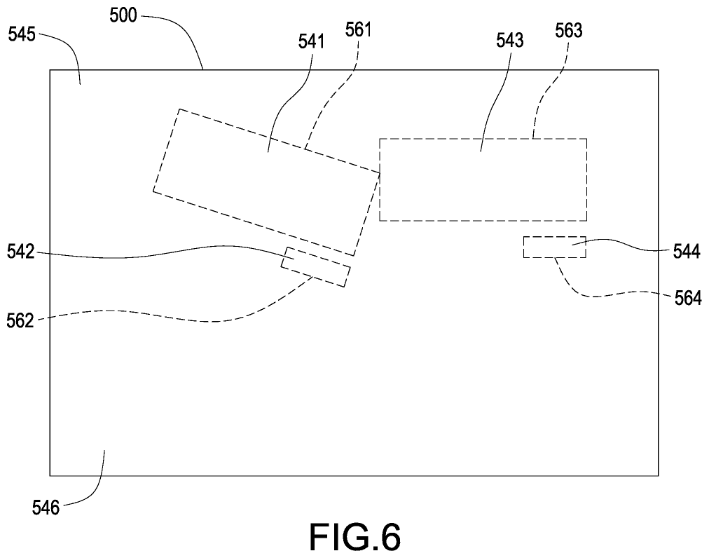

Reference is made to FIG. 6. FIG. 6 is a schematic diagram illustrating a minimum bounding rectangle computed from the binary image illustrated in FIG. 5 in accordance with one embodiment of the present disclosure. As described above, the binary image 500 includes the image object contours of the regions 541 to 546.

In one embodiment, before computing the minimum bounding rectangle, the processing device 120 determines whether the image object contours are rectangles. As shown in FIG. 5, the image object contours of the regions 541, 542, 543, and 544 are rectangles, and the image object contours of the regions 545 and 546 are not rectangles. The process of determining whether the image object contours are rectangle may be implemented by the algorithm of detecting the geometric feature of the image contour, and it is not limited herein.

In one embodiment, the processing device 120 filters the image object contours which are not rectangles (such as the regions 545 and 546 shown in FIG. 5). The filtered image object contours are not processed in step S440 for comparison, so the computation cost is reduced. In other words, the image object contours being rectangle are processed in step S440 of comparison.

In one embodiment, the image object contours being rectangle may be a closed pattern and an unclosed pattern. The closed pattern indicates a pattern that the link or edge between all the adjacent vertices forms the geometric pattern and the pattern is closed. The unclosed pattern indicates a pattern that the geometric pattern has at least one opening. For example, the region 543 shown in FIG. 5 is rectangle and the left side of the external contour of the region 543 has an opening, so the region 543 is the unclosed pattern.

In one embodiment, after computing the minimum bounding rectangle (i.e., the image object contours which are not rectangle are filtered), the processing device 120 determines whether the image object contour(s) being rectangle is(are) the unclosed pattern. If the image object contours being rectangle are the unclosed pattern, the processing device 120 executes an abnormal detecting procedure to determine whether any abnormal situation occurs. It should be noted that the situation of the rectangle image object contour belonging to the unclosed pattern represents that a location status of the plurality of to-be-detected objects is disarranged. For example, the objects are adjacent to each other or partially overlapped, so the opening of the unclosed pattern is made because one object is partially overlapped by another object. Therefore, the abnormal detecting procedure is executed to eliminate the abnormal status of the location status of the plurality of to-be-detected objects.

In one embodiment, referring back to FIG. 3, the abnormal detecting procedure executed by the processing device 120 includes determining whether an image feature block is identified from the initial image 300. For example, the image feature block of the initial image 300 is the number key ‘7’, ‘4’, ‘1’, and ‘0’ of the button 205. If the processing device 120 can identify the image feature block of the initial image 300 in the abnormal detecting procedure, it means that the location status of the to-be-detected objects is in normal status and the process moves to step S440. If the processing device 120 cannot identify the image feature block of the initial image 300 in the abnormal detecting procedure, it means that the location status of the to-be-detected objects is in abnormal status and the process does not go to step S440 and an abnormal warning is sent instead for notifying the user of the abnormal status to solve the problem.

In step S440, the minimum bounding rectangle of each of the plurality of the image object contours is compared with a default rectangle, and the minimum bounding rectangle matching the default rectangle is chosen to be a positioning region by the processing device 120.

In one embodiment, the default rectangle is the rectangle having the same size as the tracking region 311 of the to-be-detected object. As shown in FIG. 6, the processing device 120 obtains the plurality of minimum bounding rectangles 561, 562, 563, and 564 from the binary image 500, chooses the minimum bounding rectangle 561 that matches the tracking region 311 (e.g., having the same size or in a tolerant error range with the tracking region 311), and records the image coordinate position of the minimum bounding rectangle 561 as the positioning region. In the embodiment, the position of the positioning region (i.e., the minimum bounding rectangle 561) corresponds to the position of the tracking region 311 of the calculator image 310 shown in FIG. 3.

In another embodiment, in the situation that the initial image includes the plurality of object-to-be-detected images being adjacent to each other but not overlapped, after executing steps S420 to S440, the processing device 120 obtains the plurality of minimum bounding rectangles matching the default rectangle from the binary image. In the embodiment, the processing device 120 chooses the minimum bounding rectangle displayed in a region of interest (ROI) of the display device 130 from the plurality of the minimum bounding rectangles to be the positioning region.

In one embodiment, the processing device 120 presets the ROI, such as the left-half region or the right-half region of the display device 130. When there are many minimum bounding rectangles matching the default rectangle and the left-half region of the display device 13 is set as the ROI, the processing device 120 chooses the position of the minimum bounding rectangle that matches the default rectangle and is displayed in the left-half region of the display device 13 to be the positioning region.

In step S450, an identifying box is generated according to the positioning region.

In one embodiment, the processing device 120 generates the identifying box by using the image coordinate of the positioning region which is chosen in step S440. The identifying box has its design style and color, and the processing device 120 generates the identifying box according to the preset design style and color.

In step S460, the initial image and the identifying box are displayed on the display device 130, and the identifying box overlays on the tracking region of one of the plurality of object-to-be-detected images.

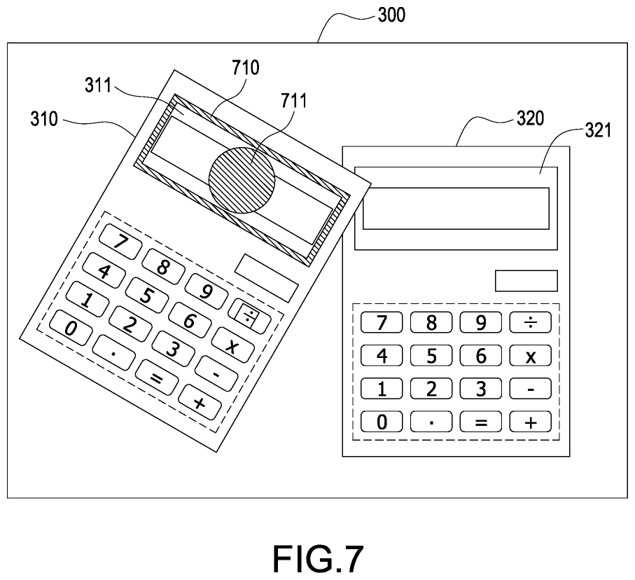

Reference is made to FIG. 7. FIG. 7 is a schematic diagram illustrating an identifying box displayed on the initial image in accordance with one embodiment of the present disclosure. As described above, the processing device 120 presets the ROI. The plurality of to-be-detected objects are placed on the platform and transported by the conveyor, so the plurality of to-be-detected objects are entered successively in the lens coverage of the image capturing device 110. After step of executing the image processing, if there are many minimum bounding rectangles matching the default rectangle in the initial image 300, for example, both the tracking region 311 of calculator image 310 and the tracking region 321 of the calculator image 320 are identified in the initial image 300 shown in FIG. 7, the processing device 120 chooses one of the plurality of minimum bounding rectangles according to the preset ROI and the chosen minimum bounding rectangle is tagged. For example, the tracking region 311 is chosen instead of the tracking region 321, and then the tracking region 311 is tagged. The ROI is set in advance and the tracking region 311 is tagged (and the tracking region 311 is certainly identified). After the conveyor operates and the tracking region 321 is shifted into the range of the preset ROI (and the tracking region 311 is shifted outside the ROI relatively), the tracking region 321 is identified successively. The abnormal detecting procedure is also executed to determine whether the preset condition is satisfied. The operation of the abnormal detecting procedure is illustrated above and is omitted herein.

As described above, the position of the positioning region obtained by the processing device 120 corresponds to the position of the tracking region 311 of the calculator image 310. Therefore, the identifying box 710 overlays on the tracking region 311 of the calculator image 310. In one embodiment, the identifying box 710 overlays along the edge of the tracking region 311.

In one embodiment, a mark may be shown inside the identifying box. As shown in FIG. 7, the identifying box 710 overlays on the tracking region 311, and the mark 711 is shown inside the identifying box 710. The mark 711 may be any geometric pattern or any designed pattern to make the tag of the to-be-detected object more obvious; therefore, the user is easier to recognize the to-be-detected object indicated currently.

In one embodiment, after any of the object-to-be-detected images is tagged by the identifying box 710, the identifying box 710 shown on the initial image 300 is moved or rotated along with the way that the to-be-detected object is moved or rotated, so the to-be-detected object is correctly tracked accordingly.

As described above, if the plurality of to-be-detected objects are adjacent to each other or partially overlapped, the to-be-detected object may be tracked incorrectly. The image tracking system and the image tracking method of the application solve the problem and correctly indicate the to-be-detected object tracking currently among the plurality of to-be-detected objects, so the user can recognize the current to-be-detected object and carry out successive tasks correctly.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image tracking method, comprising:
capturing an initial image by an image capturing device, wherein the initial image comprises a plurality of object-to-be-detected images, each object-to-be-detected image comprises a tracking region and a main region, wherein a pixel difference between the tracking region and the main region is greater than a threshold;
executing an image processing on the initial image to obtain a binary image, wherein the binary image comprises a plurality of image object contours;
computing respectively a minimum bounding rectangle of each of the plurality of image object contours;
comparing the minimum bounding rectangle of each of the plurality of the image object contours with a default rectangle to choose the minimum bounding rectangle matching the default rectangle to be a positioning region;
generating an identifying box according to the positioning region; and
displaying, on a display device, the initial image tagged with the identifying box, wherein the identifying box overlays on the tracking region of one of the plurality of object-to-be-detected images.

2. The image tracking method of claim 1, before obtaining the binary image, further comprising:
choosing a binary threshold for the image processing and the default rectangle; and
storing the binary threshold and the default rectangle in a storage medium.

3. The image tracking method of claim 2, wherein step of executing the image processing on the initial image to obtain the binary image comprises:
converting a pixel of the initial image by using the binary threshold in the image processing, such that the pixel of the tracking region is converted into a first color pixel which is one of a black pixel and a white pixel of the binary image, and the pixel of the main region and the pixel of a plurality of small blocks in the initial image are converted into a second color pixel which is the other of the black pixel and the white pixel of the binary image.

4. The image tracking method of claim 3, wherein the first color pixel is the white pixel and the second color pixel is the black pixel.

5. The image tracking method of claim 2, wherein the tracking region is an image of a black pixel, and the main region comprises the image having a white pixel and a plurality of small blocks having pixel values between white color and black color;
wherein step of executing the image processing on the initial image to obtain the binary image comprises:
converting the pixels of the initial image by using the binary threshold in the image processing, such that the pixel of the tracking region is converted into the white pixel and the pixel of the main region and the pixel of the plurality of small blocks are converted into the black pixel.

6. The image tracking method of claim 1, wherein step of choosing the image object contour matching the default rectangle to be the positioning region further comprises:
choosing the minimum bounding rectangle, that is matching the default rectangle and displayed at a region of interest (ROI) of the display device, to be the positioning region.

7. The image tracking method of claim 6, wherein the ROI is a left-half region or a right-half region of the display device.

8. The image tracking method of claim 1, wherein the tracking region is a hollow rectangle having a width in the object-to-be-detected image.

9. The image tracking method of claim 1, wherein the plurality of object-to-be-detected images correspond to a plurality of to-be-detected physical objects, and at least two of the plurality of to-be-detected physical objects are adjacent to each other or partially overlapped.

10. The image tracking method of claim 1, after step of computing respectively the minimum bounding rectangle of each of the plurality of image object contours, further comprising:
executing an abnormal detecting procedure to detect whether a location status of the plurality of to-be-detected objects is abnormal when at least one of the plurality of image object contours is determined to be a rectangle having an unclosed pattern; and
sending an abnormal warning when the location status of the plurality of to-be-detected objects is determined to be abnormal, wherein the abnormal warning is associated with an abnormal status generated based on the location status of the plurality of to-be-detected objects;
wherein the rectangle having unclosed pattern comprises an opening.

11. An image tracking system, comprising:
an image capturing device, configured to capture images on a plurality of to-be-detected objects to obtain an initial image, wherein the initial image comprises a plurality of object-to-be-detected images, each of the plurality of object-to-be-detected images comprises a tracking region and a main region, and a pixel difference between the tracking region and the main region is greater than a threshold;
a display device, configured to display the initial image; and
a processing device, connected with the image capturing device and the display device, and the processing device is configured to execute an image processing on the initial image to obtain a binary image, wherein the binary image comprises a plurality of image object contours, and the processing device is configured to compute respectively a minimum bounding rectangle of each of the plurality of image object contours, compare the minimum bounding rectangle of each of the plurality of the image object contours with a default rectangle to choose the minimum bounding rectangle matching the default rectangle to be a positioning region, generate an identifying box according to the positioning region, and display, on a display device, the initial image tagged with the identifying box, wherein the identifying box overlays on the tracking region of one of the plurality of object-to-be-detected images.

12. The image tracking system of claim 11, further comprising:
a storage medium, connected with the processing device, configured to store a binary threshold and the default rectangle;
wherein the processing device is configured to choose the binary threshold for the image processing to execute the image processing for obtaining the binary image.

13. The image tracking system of claim 12, wherein the processing device is configured to convert a pixel of the initial image by using the binary threshold in the image processing, such that the pixel of the tracking region is converted into a first color pixel which is one of a black pixel and a white pixel of the binary image, and the pixel of the main region and the pixel of a plurality of small blocks in the initial image are converted into a second color pixel which is the other of the black pixel and the white pixel of the binary image.

14. The image tracking system of claim 13, wherein the processing device is configured to set the first color pixel to be the white pixel and set the second color pixel to be the black pixel in the image processing.

15. The image tracking system of claim 12, wherein the tracking region is an image of the black pixel, and the main region comprises an image having a white pixel and a plurality of small blocks having pixel values between white color and black color;
wherein the processing device is configured to convert the pixels of the initial image by using the binary threshold in the image processing, such that the pixel of the tracking region is converted into the white pixel and the pixel of the main region and the pixel of the plurality of small blocks are converted into the black pixel.

16. The image tracking system of claim 11, wherein the processing device is configured to choose the minimum bounding rectangle, that is matching the default rectangle and displayed at a region of interest (ROI) of the display device, to be the positioning region.

17. The image tracking system of claim 16, wherein the processing device is configured to set a left-half region or a right-half region of the display device to be the ROI.

18. The image tracking system of claim 11, wherein the tracking region is a hollow rectangle having a width in the object-to-be-detected image.

19. The image tracking system of claim 11, wherein the plurality of object-to-be-detected images correspond to a plurality of to-be-detected physical objects, and at least two of the plurality of to-be-detected physical objects are adjacent to each other or partially overlapped.

20. The image tracking system of claim 11, wherein the processing device is configured to execute an abnormal detecting procedure to detect whether a location status of the plurality of to-be-detected objects is abnormal when at least one of the plurality of image object contours is determined to be a rectangle having an unclosed pattern, and send an abnormal warning when the location status of the plurality of to-be-detected objects is determined to be abnormal, wherein the abnormal warning is associated with an abnormal status generated based on the location status of the plurality of to-be-detected objects; wherein the rectangle having unclosed pattern comprises an opening.
